(19) United States
(12) Patent Application Publication
(10) Pub. No.: US 2006/0141538 A1
(43) Pub. Date: Jun. 29, 2006

(54) Automatic large-scale screening of cells secreting monoclonal antibodies

(75) Inventors: Jean Kadouche, Paris (FR); Marc Lechuga, Paris (FR); Albert Roseto, Chatou (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: MONOCLONAL ANTIBOBDIES THERAPEUTICS, Evry (FR)

(21) Appl. No.: 10/560,947

(22) PCT Filed: Jun. 15, 2004
(86) PCT No.: PCT/FR04/01482

§ 371 Date: Dec. 15, 2005

(30) Foreign Application Priority Data
Jun. 16, 2003 (FR) 03/07191

(51) Int. Cl. C40B 40/10

(52) U.S. Cl. 435/7.2

(57) ABSTRACT

The invention relates to an automatic method for the large-scale in vitro screening of cells, secreting at least one specific monoclonal antibody with affinity for a compound of interest, comprising: (10) distribution of antibody-producing cells on at least one culture plate, (12) culturing of said cells, (14) iterative screening of said cells for the secretion of antibodies with cloning of the cells secreting at least one antibody interacting with the compound of interest and (16) selection of at least one cell secreting a specific monoclonal antibody with affinity for said compound of interest.

The present invention relates to the field of the identification and selection of monoclonal antibodies having advantageous properties in particular in terms of specificity and affinity. The invention relates more specifically to the improvement of the procedures and the production of effective means for the purpose of screening such antibodies.

The subject-matter of the present invention is an automated method for the large-scale in vitro screening of cells secreting at least one specific monoclonal antibody with affinity for a compound of interest, said antibody being particularly useful for research, diagnostic and/or therapeutic purposes.

The present application also describes a method for improving the production, by an animal, of cells producing antibodies directed against a compound of interest, by stimulating the immune response of the animal and by increasing the number of different antibodies produced by said cells and directed against the compound of interest.

Antibodies belong to the immunoglobulin family. They are produced by the B lymphocytes (or B cells or alternatively “antibody-producing cells”).

Antibodies represent an active means essential for the defense of a host organism against a foreign compound. Such a compound may be for example a parasite, a virus, a bacterium, a polypeptide, a polysaccharide and the like.

In accordance with usage, the foreign compound referred to above is an “antigen” capable of triggering an immune response in the host organism. More specifically, each antigen comprises one or more “epitopes”, consisting of the specific part(s) of the latter, which react with the antibody or antibodies.

The antigen and the antibody bind according to a “ligand-receptor” type reaction. More particularly, the antibody has, at its surface, a site called “paratope”, capable of recognizing the antigen and corresponding to the site for specific binding with an epitope of this antigen.

In response to the presence of an antigen, the body's immune system reacts by producing as many different types of antibody as there are epitopes in the antigen.

Dendritic cells are also called “sentinel cells” or “antigen-presenting cells”. These cells allow the stimulation of the humoral and cellular immune system.

The process consisting in capturing the infectious or tumor antigens, the degradation of the latter in the dendritic cells and the presentation of the epitopes by these cells are known (Dendritic cells: biology and clinical applications. Ed. M. T. Lotze, A. W. Thomson, Academic Press, 1999). Briefly, the infectious or tumor agents are recognized and degraded inside the dendritic cells. Next, the, fragments thus obtained are presented at the surface of the cells. These foreign fragments are then recognized by the lymphocytes. The humoral and cellular immune process thus solicited leads to the production of antibodies directed against these tumors and/or these infectious agents.

The recruitment of dendritic cells and the epitope-presenting process are essential steps in the immune response.

The immune response induced by the presence of an antigen comprises the simultaneous production, by a polyclonal population of B lymphocytes (i.e. a heterogeneous population composed of several types of B lymphocyte), of a multitude of antibodies. In this regard, this immune response is polyclonal in that it results from the production of several types of antibody, each type of antibody being produced by one type of B lymphocyte.

However, the use of polyclonal antibodies for research or diagnostic purposes, and especially in the context of prophylactic and/or therapeutic treatments, obviously poses problems of specificity toward a particular antigen.

These problems have up until now been largely resolved by virtue of the work by Köhler and Milstein, published in 1975 (Nature 256: 495-497). They indeed developed a technique for producing monoclonal antibodies, that is to say antibodies that are homogeneous and of defined specificity. By virtue of this method and the molecular biological techniques which have now become conventional, the preparation of tailor-made monoclonal antibodies, in unlimited quantities, is of considerable interest in clinical medicine, industry and scientific research.

At the present time, it is theoretically possible to design monoclonal antibodies against any type of substance, which was previously difficult to envisage. In general, monoclonal antibodies, by virtue of their specificity and their affinity toward particular antigens, constitute identification tools having very vast fields of application analytical, cytological, histological, functional or biochemical studies. Monoclonal antibodies are thus very widely used in diagnosis and in medical and pharmaceutical research. They also find novel uses in therapy.

Biotechnology companies and laboratories have up until now adopted various approaches and techniques in order to identify the “best” monoclonal antibody, i.e. the monoclonal antibody which is the most specific and which has the highest affinity for an antigen involved in the etiology of a given disease. The best antibody thus identified could therefore be advantageously used in the context of the diagnosis, prevention and/or treatment of this disease. However, researchers and engineers do not create an antibody in the same way as a chemical molecule could be synthesized. In fact, their work essentially consists in determining, among the 10¹¹ types of antibody produced by the immune system of humans or animals, the antibodies which best correspond to the antigens in question. The strategy is therefore based on the identification and selection of the best monoclonal antibody or antibodies among a group of potential candidates. This is what is commonly called “screening”.

Genomic companies specialized in the development of monoclonal antibodies have antibody libraries which are potentially candidates for combating a large number of diseases. In order to reduce the number of potential candidates, all the antibodies of the library are brought into contact with an antigen. Next, the antibodies which exhibit the highest affinity for this antigen are selected. However, the libraries consist, not of complete antibodies, but of antibody fragments (so-called phage display technology). Thus, most often, these companies succeed in rapidly identifying antibody fragments of interest. They encounter, on the other hand, great difficulties as regards obtaining a complete antibody. Indeed, the libraries of antibody fragments are generally not representative of the entire 10¹¹ types of distinct antibodies which the immune system of an organism is capable of producing. Accordingly, it is necessary to reconstitute, by engineering techniques, complete antibodies from selected antibody fragments, which may result in the construction of antibodies of insufficient specificity and/or affinity.

Cell biology companies have adopted a different approach. Antigens, individualized or not, are injected into animals (humanized transgenic mice or rats). Next, by conventional somatic hybridization, but using humanized transgenic mice or rats, a cellular complex is identified, said complex comprising, inter alia, the antibodies which were produced by the mouse or the rat in the presence of the injected antigens. However, these companies do not have the capacities and means necessary for, carrying out a rapid and inexpensive screening which makes it possible to identify each antibody of interest produced by the immune system. Indeed, insofar as this approach does not involve techniques capable of being used on a large scale, it is necessarily limited in that all the antibodies which are potentially of interest cannot be identified by a single screening. Consequently, it is likely that the candidates thus identified are finally not the best in terms of specificity and/or affinity.

In addition, it is currently impossible, according to either of these approaches, to study in detail the epitopes to which the selected antibodies bind, without these epitopes being identified beforehand.

In fact, it is currently absolutely essential to have procedures and means allowing: on the one hand, the identification of the best antibodies in terms of specificity and/or affinity, and on the other hand, the identification of the epitopes recognized by these antibodies.

The method which is the subject-matter of the present invention, wherein most of the steps and, in any case, wherein all the essential steps, can be automated, satisfies such concerns for acuity of screening (selecting the best antibody or antibodies for a given application and, where appropriate, identifying the epitopes in question), rationalization and savings, in that it: (i) allows the identification and the selection of the best antibody or antibodies among a large number of potential candidates; (ii) makes it possible to carry out epitope mapping; (iii) is quick to carry out; (iv) provides reproducible results; (v) makes it possible to simultaneously screen a large number of antibody-producing cells; (vi) can be carried out by nonspecialist staff; and (vii) can be carried out for routine screening purposes in order to meet the needs of the research or analytical laboratory, hospital structure or industry.

For that, the method according to the invention advantageously combines large-scale cellular screening and proteomic technology making it possible to precisely identify the antigen and/or the epitope(s) recognized by a given antibody.

By virtue of this recognition, the invention now allows optimum screening of antibodies by the identification of the best antibody or antibodies for a given application. Thus, the statistical relevance of screening is improved insofar as the method which is the subject-matter of the present invention not only increases the quantity of different monoclonal antibodies secreted by the cells subjected to the screening, but also the quality of these antibodies, in terms of specificity and/or affinity.

The subject-matter of the present invention is therefore an automated method for the large-scale in vitro screening of cells secreting at least one specific monoclonal antibody with affinity for a compound of interest.

The expression “automated” should be understood to mean that all the essential steps of the method in accordance with the invention may be, and are preferably, advantageously automated. In addition, unless otherwise stated in the remainder of the text, the steps of the particular embodiments of the method according to the invention may be, and are preferably, also automated.

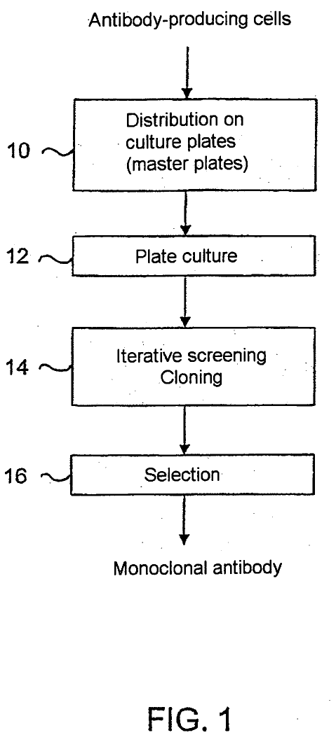

According, to a first embodiment illustrated by FIG. 1, this method comprises at least the following steps:
(10) distribution of antibody-producing cells in at least one well of at least one culture plate;
(12) culturing said cells (plate culture) under conditions allowing their growth, with concomitant detection of cellular growth and of the quality of the cultures;
(14) iterative screening of said cells for the secretion of antibodies, with cloning of the cells secreting at least one antibody interacting with said compound of interest; and
(16) selection of at least one cell secreting one specific monoclonal antibody with affinity for said compound of interest.

For the purposes of the invention, a “compound of interest” is an antigen comprising at least one epitope. Such a compound is chosen in particular from: proteins, nucleic acids, viral particles, synthetic peptides, chemical compounds, organs, organelles (for example Golgi apparatus, mitochondria, and the like), whole cells (for example mammalian cells, plant cells, bacteria and the like), subcellular fragmentations, (for example fragments of cellular membranes, of mitochondria and the like). In particular, the abovementioned compound is a tumor cell. In such a case, the method in accordance with the present invention will be advantageously used on the tumor cell of interest and, in parallel, on a normal cell derived from the same tissue (normal cell corresponding to the tumor cell).

The “culture plates”, “screening plates” (used during step (14) of iterative screening indicated above), and “storage plates” for constituting cell libraries, are as conventionally used for cell cultures. In particular, such a plate comprises 6, 12, 24, 96 or 384 wells. Preferably, it comprises 96 or 384 wells.

The culture plates obtained during the abovementioned step (10) represent, in the context of the invention, the “master culture plates”.

Preferably, the distribution of the cells according to step (10) is carried out in an amount of at least 3×10⁵ cells per well.

The “plate culture” of the cells in accordance with step (12) is carried out in a conventional selective medium (for example: RPMI medium, 1% mixture of penicillin/streptomycin, 1% pyruvate, 2% glutamine, 10% fetal calf serum, 1% 8-azaserine., 1% hypoxanthine), generally over a period of between at least 7 days and at most 21 days, said period being preferably between 7 and 15 days. In practice, this period depends on the density of the cells in the wells. Once the culture period has elapsed, the culture medium is changed automatically. Thus, the old medium is collected and used in the context of the iterative screening [step (14)], while the new culture medium is added to the wells of the master plates.

The “detection of cell growth” concomitantly with the culture [step (12)] may be carried out manually by an operator. In this case, a statistical test may be used. The following estimators may be used.
Estimator c: “the well is contaminated”, with p(c) distributed according to a binomial law B(n,p), where n is the number of wells observed by a qualified operator, and p the probability for a well to be contaminated; c takes the discrete value 1 if the well is contaminated, or 0 if nothing abnormal is observed. According to the maximum likelihood theorem, the test is 95% reliable if n=30. The operator therefore observes 30 different wells randomly chosen as follows. The wells are numbered from 1 to N, with 1, the number for the first well of the first 96-well culture plate (coordinates on the plate: Al), and N the number for the last well of the last 96-well culture plate (coordinates on the plate: H12). The numbers for the wells to be observed are randomly chosen from the list by means of a random number generator (MS Excel).
Estimator C: “at least one well observed is contaminated”, with p(C) distributed according to a binomial law B(1,P), where P, the probability for 30 wells to be contaminated, takes the discrete value 1 if at least one well is contaminated, or 0 if nothing abnormal is observed. If P(C)=0, it is considered that all the culture wells are free of contamination with a 95% reliability. The mean cell growth is empirically evaluated by the operator on the 30 wells observed.

Alternatively and preferably, this detection is automated, for example by means of at least one technique chosen from:
calorimeter analysis of the pH of the culture medium;
measurement of the pH of the culture medium with the aid at least one probe;
analysis of the image of the wells of the plates;
measurement of the conductivity of the culture medium by means of a microelectrode;
turbidimetry; or
any combination of these techniques.

These are conventional techniques known to a person skilled in the art.

For the purposes of the invention, the “quality of the cultures” refers to the absence of contamination of said cultures.

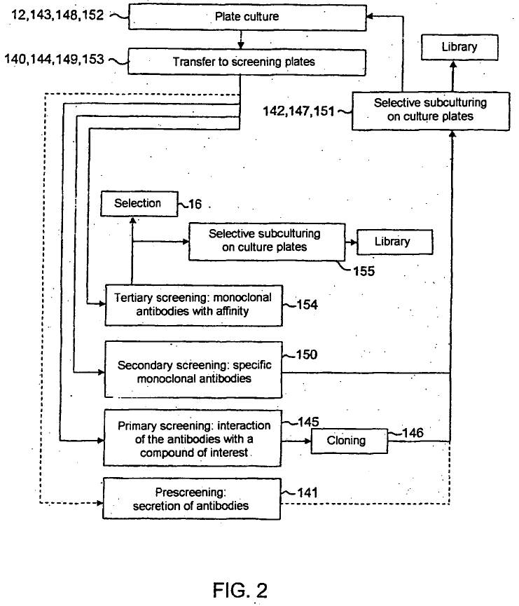

According to a second embodiment illustrated by FIG. 2, step (14) of iterative screening comprises at least the following screening module:
transfer of the culture medium collected from at least one well of at least one culture plate (#n), into at least one well of at least one screening plate (#n);
screening of the cells for at least one given selection criterion;
selective subculturing of the cells satisfying said criterion into at least one well of at least one new culture plate (#n+1); and
culture of said cells (“plate culture”) under conditions allowing their growth, with concomitant detection of cell growth and of the quality of the cultures.

The expression “module” is understood here to mean a succession of steps which can be repeated several times, in a loop. Thus, from one module to the next, the following will change:
the initial culture plates (#n), from which the culture medium (also called here “culture supernatant”) is removed and transferred;
the screening plates (#n);
the selection criterion or criteria; and
the culture plates (#n+1).

For the purposes of the present invention, the selection criterion is chosen from the following criteria (see FIG. 2): the secretion of antibodies (“prescreening”); the secretion of antibodies interacting with the compound of interest (“primary screening”); the secretion of monoclonal antibodies specific for said compound of interest (“secondary screening”) and the secretion of specific monoclonal antibodies with affinity for said compound of interest (“tertiary screening”). Preferably, all these criteria are successively applied in the order indicated above. Under these conditions, the abovementioned module is repeated four times. It is nevertheless possible to omit the prescreening criterion. The primary screening is then carried out straight away, reducing the number of repeats of the above module to three.

Advantageously, when the primary screening is carried out, whether it is preceded by the prescreening or not, an additional cell cloning step is performed, as detailed below [step (146); see also FIG. 2].

In addition, the final module performed, corresponding according to the invention to the tertiary screening, does not necessarily comprise the steps of selective subculturing Rand culturing on plates. Indeed, the actual tertiary screening is preferably followed by at least one step of selection of at least one cell secreting a monoclonal antibody whose specificity and/or affinity for the compound of interest are higher than those of monoclonal antibodies secreted by the other cells [step (16), see FIGS. 1 and 2].

The expression “selective subculturing of the cells” corresponds to the usual meaning in the field of cell biology.

In principle, in the context of the iterative screening [step (14)], the plate cultures are performed in standard medium (for example: RPMI medium, 1% mixture of penicillin/streptomycin, 1% pyruvate, 2% glutamine, 10% fetal calf serum). The culture times for step (14) are identical to the periods indicated above in the case of step (12).

The “detection of cell growth” is as defined above for step (12).

Firstly, the optional prescreening module comprises at least the following steps:
(140) transfer of the culture medium collected from at least one master culture plate (at the end of step (12)], to at least one screening plate (screening plate #0);
(141) prescreening of the cells for the secretion of antibodies;
(142) selective subculturing of the cells on at least one culture plate (culture plate #1); and
(143) plate culture of said cells.

Step (141) corresponds to a qualitative screening, comprising at least:
(1411) the detection of the secretion of antibodies; and
(1412) the selection of cells secreting at least one antibody.

More specifically, step (1411) of detection of the secretion of antibodies comprises at least:
(14111) the collection of at least one culture supernatant sample; and
(14112) the detection of the secretion of antibodies in this sample.

Alternatively, this step (1411) comprises at least the detection of the secretion of antibodies directly in the wells.

The prescreening according to step (141), in particular step (1411) above, can be carried out with the aid of any system for detecting a “ligand-receptor” type linkage, known to a person skilled in the art. By way of examples, there may be mentioned immunodetection systems which use isotopes or enzymes, techniques based on the detection of luminescence or fluorescence, methods using microprobes, and the like. In particular, persons skilled in the art have available conventional ELISA (for Enzyme-linked ImmunoSorbent Assay) techniques, “TopCount” or “Alpha Screen” systems (Perkin Elmer Life Sciences Inc., Boston, Mass., United States), or FMAT 8100 or FMAT 8200. systems (Applied Biosystems, Manchester, Great Britain). The use of prescreening may involve in particular conventional micro- or nanotechnology-based means. The sample volumes required are in this case advantageously less than 10 μl.

Secondly, the primary screening module comprises at least the following steps:
(144) transfer of the culture medium, collected from at least one culture plate #1 if the prescreening has been carried out, or from at least one master culture plate in the opposite case, to at least one screening plate (screening plate #1);
(145) primary screening of the cells for the secretion of at least one antibody interacting with the compound of interest;
(146) cloning of the cells secreting at least one antibody interacting with said compound of interest;
(147) subculturing of the cloned cells on at least one culture plate (culture plate #2); and
(148) plate culture of said cells.

The detection of an interaction in each of the wells of a screening plate, in accordance with the primary screening step (145), is qualitative. This step (145) comprises at least:
(1451) the collection of at least one culture supernatant sample;
(1452) the detection, in this sample, of the interaction of the antibodies with the compound of interest; and
(1453) the selection of cells secreting at least one antibody interacting with said compound of interest.

The primary screening referred to in step (145) may be carried out with the aid of the same techniques as those cited for the prescreening. Here again, the primary screening may involve micro- or nanotechnology-based means. Thus, the sample volumes are advantageously less than 10 μl.

The cloning which is the subject of step (146) is aimed at passing from polyclonal cell populations present in the wells of the prescreening and/or primary screening plates, to monoclonal cell populations. Such a cloning may be carried out by conventional methods well known to persons skilled in the art. For example, there may be mentioned cell sorting by flow cytometry, limiting dilution, performed on a culture plate (generally 96 wells) in standard medium, and cloning in agar, medium. At the end of step (146), cells secreting a monoclonal and monospecific antibody are therefore present in each well.

Thirdly, the secondary screening module comprises at least the following steps:
(149) transfer of the culture medium collected from at least one culture plate #2, to at least one screening plate (screening plate #2);
(150) secondary screening of the cells for the secretion of a monoclonal antibody specific for the compound of interest;
(151) selective subculturing of the cells on at least one culture plate (culture plate #3); and
(152) plate culture of said cells.

The secondary screening step (150) corresponds again to a qualitative screening. To this effect, this step (150) comprises at least:
(1501) the collection of at least one culture supernatant sample;
(1502) the detection, in this sample, of a specific interaction between a monoclonal antibody and the compound of interest; and
(1503) the selection of cells secreting a monoclonal antibody specific for said compound of interest.

This secondary screening may be performed with the aid of the techniques indicated above for the prescreening and primary screening. In a particularly advantageous manner, the sample volumes necessary are less than 10 μl.

The notion of “specificity” should be understood here in relation to a particular epitope of the compound of interest. Two scenarios may be envisaged.
(i) The compound of interest is a tumor cell. A differential secondary screening is performed in this case, that is to say that the results obtained from the qualitative detection of the “monoclonal antibody—normal cell of the same tissue” linkage compared with the “monoclonal antibody—tumor cell” linkage are compared. It is considered in this case that the “monoclonal antibody—tumor: cell” linkage satisfies the criterion of specificity if it is detected, whereas a significantly weaker, or even nonexistent, “monoclonal antibody—normal cell of the same tissue” linkage is detected.
(ii) The compound of interest is different from a tumor cell. It is appropriate, in this case, to carry out mapping of the epitope(s), and then to qualitatively determine if the monoclonal antibody binds to a particular epitope. There is said to be “specific binding” between the antibody and this epitope if the latter condition is fulfilled.

If the compound of interest is a tumor cell, persons skilled in the art may, for a better result, combine the differential secondary screening [case (i)] with epitope mapping [case (ii)].

Fourthly, the tertiary screening module, which is the final module here, comprises at least the following steps:
(153) transfer of the culture medium collected from at least one culture plate #3, to at least one screening plate (screening plate #3); and
(154) tertiary screening of the cells for the secretion of a specific monoclonal antibody with affinity for said compound of interest.

Optionally, this module additionally comprises:
(155) selective subculturing of the cells on at least one culture plate (culture plate #4); and
(156) plate culture of said cells.

The tertiary screening which is the subject of step (154) makes it possible to quantitatively compare the affinity and the specificity of the monoclonal antibodies and, where appropriate, to establish a map of the epitopes carried by the compound of interest. Thus, step (154) comprises at least:
(1541) the collection of at least one culture supernatant sample; and
(1542) the measurement of the affinity of a monoclonal antibody for the compound of interest.

More specifically, the above step (1542) comprises at least:
(15421) the measurement of the affinity of a monoclonal antibody for the compound of interest; and
(15422) the identification and/or the location of at least one epitope of said compound of interest.

The identification and/or the location of epitopes (epitope mapping) are also designated here by the expression “epitope mapping”.

Advantageously, the abovementioned steps (15421) and (15422) may be concomitant.

Advantageously, the tertiary screening step (154) additionally comprises:
(1543) the classification of the monoclonal antibodies on the basis of their specificity and/or their affinity for the compound of interest.

The antigen-antibody complex is obtained by spatial complementarity and via the establishment of bonds of low energy (such as hydrogen, electrostatic, Van der Waals or hydrophobic bonds) between the two paratopes and the epitope. The sum of these interactions represents a more or less strong overall interaction depending the specificity of the antibody for the epitope. In fact, the antigen-antibody combination is reversible, with an interaction energy which varies from one epitope-paratope pair to another.

In a 1:1 kinetic model, or monovalent model, the interaction energies of each of the two paratopes are not taken into consideration. The overall interaction energy (namely the energy of dissociation of the complex) is greater than the arithmetic sum of the interaction energies of the two paratopes. This overall energy is characterized by an equilibrium constant, called “affinity constant” or “association constant” K_{D}, expressed in L/mol or M⁻¹, and by two kinetic association and dissociation constants, kₐ and k_{d} respectively (expressed in M⁻¹ or min⁻¹). Physically, K_{D} represents the inverse of the minimum antibody concentration necessary for the reaction of formation of the complex to be at equilibrium for a given antigen. The affinity constant K_{D} is given by the following formula: 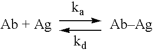
K_{D}=kₐ/k_{d}=[Ab−Ag]/([Ab]·[Ag])
where: [Ab]=antibody concentration
[Ag]=antigen concentration
[Ab−Ag]=concentration of antigen-antibody complex.

In the 2:1 kinetic model, or bivalent model, which is closer to reality, the kinetic association and dissociation constants of each paratope are considered: kₐ₁, k_{d1} for one site, and kₐ₂ and k_{d2} for the other site. The calculation of an overall constant K_{D} is impossible in this case. Such a model takes into account the fact that the interaction with one site determines the interaction with the other site, depending on the accessibility of the epitope. The following reactions are called into play in this case: 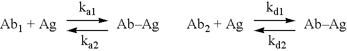
where: Ab₁: first site of interaction of the antibody (or paratope No. 1).
Ab₂: second site of interaction of the antibody (or paratope No. 2).

The constants kₐ₁, k_{d1}, kₐ₂, k_{d2} may then be graphically measured by linearization of standard curves.

In practice, the tertiary screening may be performed in particular by means of a device of the Biacore 3000 or Biacore S51 type (Biacore AB, Paris, France). These devices allow the measurement of the kinetics of interaction of an antibody with an antigen, the associated constants for each of the models described above, and the R₅₀, namely the signal obtained for 50% of bound antibodies. To do this, they use the measurement of the variation of energy of the cloud of free electrons of a metal (or plasmon) when it is excited by a beam of polarized light. According to one mode of experimentation, the antibodies are bound to a metal plate subjected to laser radiation. An antigen solution is then injected and “passes” over the bound antibodies with a known flow rate, for a specific period. The apparatus then measures the variations in plasmon energy as a function of the binding of the antigen. The calculation of the constants is carried out automatically with the aid of the experimental results thus obtained.

Alternatively, the measurement of the binding affinity [step (15421) mentioned above], represented by the constants K_{D}, R₅₀, kₐ, k_{d} in the case of the 1:1 kinetic model, or R₅₀, kₐ₁, k_{d1}, kₐ₂, k_{d2} in the case of the 2:1. kinetic model, and the epitope mapping [abovementioned step (15422)] are carried out by means of at least one technique for kinetic analysis of ligand-receptor interaction such as:
an RIA test,
an ELISA test;
conventional proteomic techniques known to a person skilled in the art; and
the use of microprobes.

More particularly, in order to map the epitopes, a conventional proteomic platform is used. Such a platform is generally composed of a 2-dimensional electrophoretic system, or 2D electrophoretic system, which makes it possible to cause proteins or protein fragments to migrate according to two parameters: their molecular weight and their charge. For example, to analyze the electrophoretic profile of a tumor cell in relation to a normal cell of the same tissue, samples of these cells are prepared in order to separate the protein fraction. Next, the samples are placed on a gel and migrate under the effect of an electric field. During visualization, it is possible to compare, either with the eye, or with the aid of a scanner and a software for image analysis, the electrophoretic profiles of the two cells, and to identify the signals or “spots” specific to the tumor cell, or the proteins overexpressed or underexpressed by the tumor cell compared with the normal cell. The spots specific to the tumor cells are then manually collected (cut out from the gel), or by means of a sampling robot whose operation is linked to computer analysis of images. The proteins entrapped in the gel fragments are redissolved in solution. Their sequence is determined using a Maldi-Toff type mass spectrometer. It is then possible to carry out a new 2D electrophoresis of the peptide fragments identified from the results thus obtained on the proteins, and, to map the epitopes of the entire protein by adding the screened antibodies to the gel. If the compound of interest is a protein, only this second 2D electrophoresis is performed, as an alternative to the epitope mapping performed using a Biacore type device (see above). The method with this device is similar to that described above: the antibodies “pass” through a lawn of peptide fragments (a single type of fragments per “lawn”) and interact with different affinities with the latter. This method has the advantage of providing, in addition to the mapping, the affinity of the interaction. However, it is more tedious to carry out than 2D electrophoresis.

According to a third embodiment, a cell library is prepared for at least one screening module of step (14), from the culture plates obtained after selective subculturing. Thus, a library is prepared at the end of:
step (142) for the prescreening module, if the latter is used; and/or
step (147) for the primary screening module; and/or
step (151) for the secondary screening module; and/or
where appropriate, step (155) for the tertiary screening module.

Preferably, a cell library is prepared for each of the screening modules cited above.

To do this, the cells subcultured on at least one culture plate [steps (142), (147), (151) and (155)] are again subcultured on at least one storage plate, where they are again cultured over a period of about 7 days. Next, the cells are collected, cultured and frozen according to techniques known to persons skilled in the art.

According to a fourth embodiment of the method which is the subject of the present invention, illustrated by FIGS. 1 and 2, step (14) of iterative screening is followed by at least:
(16) the selection of at least one cell secreting a monoclonal antibody with specificity and/or affinity for the compound of interest greater than those of the monoclonal antibodies secreted by the other cells.

It is possible for this step (16) not to be automated.

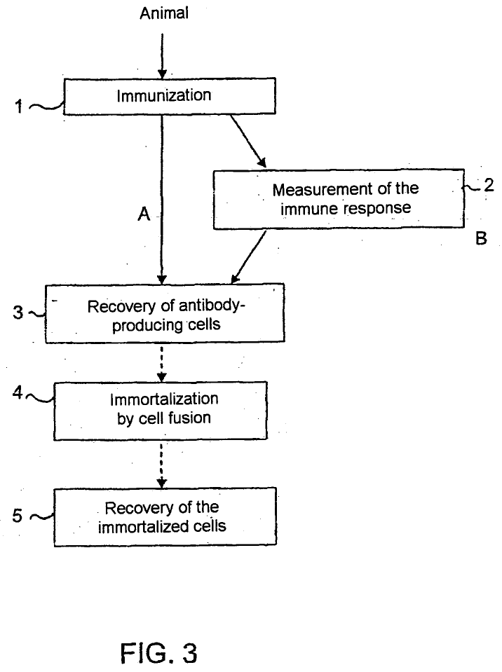

According to a fifth embodiment illustrated by FIG. 3, the distribution step (10) mentioned above is at least preceded by the following preliminary steps:
(1) immunization of at least one animal, with the compound of interest;
(2) optionally, measurement of the immune response of said animal; and
(3) recovery of the antibody-producing cells.

Alternatively, at least the following preliminary steps precede the distribution step (10):
(0) bringing at least one dendritic cell (or “antigen-presenting cell”) and the compound of interest into contact, such that said dendritic cell presents at least one epitope of said compound of interest;
(1) immunization of at least one animal, with said dendritic cell presenting said epitope;
(2) optionally, measurement of the immune response of said animal; and
(3) recovery of the antibody-producing cells.

At the end of step (0) of bringing into contact, the dendritic cell has internalized and cut the compound of interest so as to present fragments of said compound at its surface, these fragments comprising, where appropriate, one or more epitopes of the compound in question.

Preferably, when the compound of interest is a tumor cell, step (0) above comprises at least:
(01) the fusion of the dendritic cell and the tumor cell; and
(02) the recovery of at least one hybrid dendritic cell.

The expression “hybrid dendritic cell” is understood to mean a dendritic cell fused with a tumor cell. Such a hybrid cell advantageously presents at its surface not only the epitopes normally presented by the tumor cell, but also the cryptic epitopes, which are not normally presented by the tumor cell. Such a cell, as example II-1 below shows, has the advantage of possessing the characteristics of the dendritic cell and of presenting more epitopes of the tumor cell than the latter, under normal circumstances.

During the immunization step (1), various adjuvants may be used, in particular complete or incomplete Freund's adjuvant, or any other mixture of proteins and glcyolipids known to persons skilled in the art for its use as immunity adjuvant in humans and/or animals.

Several inoculation routes may be envisaged. In particular, the subcutaneous, intradermal, intravenous, intraperitoneal and intrasplenic routes, and the like, may be mentioned.

The inoculation may be performed with the aid of a single compound of interest or a combination of such compounds, according to programs of time intervals and quantities of compound(s) of interest which may vary.

The immunization techniques in order to produce antibodies form part of the general knowledge of persons skilled in the art.

The above optional step (2) corresponds to the measurement of the humoral immune response of the immunized animal. This step (2) may be advantageously carried out with the aid of conventional methods. For example, a blood sample is collected from the animal. The circulating G immunoglobulins specific for the compound of interest are then assayed by ELISA.

The recovery of the antibody-producing cells according to step (3) consists, for example, in sacrificing the animal in order to collect its spleen. The cells are then dissociated in the usual manner.

By way of examples of antibody-producing cells suitable for carrying out the method which is the subject of the present invention, there may be mentioned mouse, rat, rabbit and human spleen cells. Preferably, the antibody-producing cells are mouse cells.

According to an advantageous, embodiment, the above preliminary steps additionally comprise (see FIG. 3):
(4) the fusion of the antibody-producing cells thus recovered with immortalized cells; and
(5) the recovery of the immortalized antibody-producing cells.

To do this, preferably, the antibody-producing cells are fused, by the operator, with tumor, in particular myeloma, cells.

According to a particular embodiment, the preliminary steps mentioned above [(1), (2), (3) and, where appropriate, (4), (5)] or [(0), (1), (2), (3) and, where appropriate, (4), (5)] are not automated.

According to a sixth embodiment, each step of the method which is the subject-matter of the present invention is performed in a sterile atmosphere. By default, all the steps of the iterative screening modules [step (14)] may be carried out in a nonsterile atmosphere, as long as the initial step of each module, corresponding to the transfer of the culture medium to screening plates [steps (140), (144), (149) and (153)], is carried out in a sterile medium. Thus, the addition of the reagents to the wells of the screening plates, the incubation of said plates and the reading of the results of the screening may be carried out in a nonsterile atmosphere, even if the compound of interest is a cell. In any case, all the steps of the method which is the subject-matter of the invention which involve antibody-producing cells are carried out in a sterile atmosphere: in particular, the plate culture steps (12), (143), (148), 152); the transfer steps (140), (144), (149), (153); the selective subculturing steps (142), (147), (151), (155); and the preparation of the cell libraries.

A device for carrying out a method as described above comprises at least one automatic system controlling:
at least one part: for controlling at least one robot; and
at least one part for data acquisition and processing.

For the purposes of the invention, an “automatic system” is a device providing an automatic and controlled sequence of tasks in accordance with the instructions of an operator.

Thus, through its operation, this automatic system tends to cancel the deviation between a controlled parameter (parameter generated by the “automatic control” means, that is to say by the automatic system itself) and a control parameter (here, the instruction generated by the operator).

According to the usual meaning, a “robot” is an automatic device capable of handling objects and executing operations according to a fixed or parameterizable program.

A “program” is a sequence of instructions, said “instructions” being orders expressed in a programming language whose interpretation results in the execution of specific elementary operations.

A “parameter” is a variable whose value, address or name is only specified during the execution of the program.

The “data” represent here the results of observations or experiments.

According to particular embodiments, said automatic system is programmed and/or parameterized by the operator (operator instructions).

The automatic system advantageously comprises in this case a memory in which at least one program and/or at least one parameter is recorded.

The device in question is such that the automatic system generates the instructions necessary for carrying out the automated steps and substeps of the method described above.

In this device, the control part of at least one robot controls itself, in accordance with the instructions generated by the automated machine, said robot.

In particular, such a robot is capable of:
seizing; moving and positioning in (x,y,z) at least one culture, or screening, or storage plate; and/or
storing said plate; and/or
collecting liquid medium from at least one well located at a predetermined position (x,y,z) of said plate; and/or
washing said well.

The data acquisition and processing part, present in this device, analyzes, in accordance with the instructions generated by the automatic system, the data provided by at least one means for the qualitative and/or quantitative detection of the cells present in at least one well of a culture or screening plate.

A detection means which is particularly suitable for use in the device in question is chosen in particular from:
a photometric unit for analyzing said well;
a unit for analyzing the image of said well;
an autoradiography unit comprising at least one means for measuring the radioactivity of said well;
a cell sorting unit comprising at least one means for separating the cells; and
a Biacore 3000 or Biacore S51 type device (see description above).

All these detection means involve conventional techniques known to persons skilled in the art.

In such a device, at least the parts which act on the antibody-producing cells themselves are in a sterile atmosphere. Thus, the parts of the device using the steps of the iterative screening modules [step (14)] may be located in a nonsterile atmosphere as long as the initial step for each module, corresponding to the transfer of the culture medium to screening plates [steps (140), (144), (149) and (153)], is carried out in a sterile medium.

Moreover, the present application discloses a method for improving the production, by an animal, of antibody-producing cells directed against a compound of interest.

In the present context, this method makes it possible to stimulate the animal's immune response and to increase the number of different antibodies produced by the cells and directed against the compound of interest.

According to a first embodiment, the method described here comprises at least the following steps:
(20) bringing at least one dendritic cell into contact with the compound of interest such that said dendritic cell presents at least one epitope of the compound of interest;
(22) immunizing an animal, with the dendritic cell presenting said epitope;
(24) optionally, measuring the immune response of said animal; and
(26) recovering the antibody-producing cells.

The “compound of interest” referred to here corresponds to the definition given above.

When the compound of interest is a tumor cell, the method preferably comprises at least the following steps:
(30) fusion of at least one dendritic cell and said tumor cell;
(32) recovering at least one hybrid dendritic cell;
(34) immunizing an animal, with said hybrid dendritic cell;
(36) optionally, measuring the immune response of said animal; and
(38) recovering the antibody-producing cells.

A dendritic cell, or an antigen-presenting cell, suitable for carrying out the method according to the invention is for example a mouse dendritic cell.

The bringing into contact referred to in step (20) is carried out in a conventional manner, for example in conventional culture plates.

The fusion according to step (30) involves conventional techniques for persons skilled in the art.

A “hybrid dendritic cell” as mentioned above corresponds to the definition above.

Steps (22), (24) and (26) or (34), (36) and (38) are as defined above.

According to a second embodiment, the method described above additionally comprises at least the following steps:
(40) fusion of the antibody-producing cells thus recovered with immortalized cells; and
(42) recovering the immortalized antibody-producing cells.

These steps are in conformity with the definitions given above.

In addition, the present application discloses the application of the method described above, for improving the production, by an animal, of antibody-producing cells, to the large-scale in vitro screening of cells secreting at least one specific monoclonal antibody with affinity for a compound of interest, in accordance with the method which is the subject of the invention.

The present invention is illustrated, without however being limited, by the following figures:

FIG. 1: schematic representation of the essentially automated method for screening cells secreting at least one monoclonal antibody—overall view.

FIG. 2: schematic representation of the steps relating to the iterative screening according to step (14) of FIG. 1—detailed view. The dotted arrows indicate the optional steps.

FIG. 3: schematic representation of the preliminary steps relating to the method schematically presented in FIG. 1. Routes A and B are alternatives.

The examples which follow are intended to illustrate, without limitation, specific embodiments of the present invention.

### EXAMPLES

I—Method of Screening:

I-1—Preliminary Steps:

These steps are illustrated in FIG. 3.

A—Steps for Immunization and Recovery of the Antibody-Producing Cells [Steps (1) and (3)]:

In the case of the immunization of a mouse with a tumor cell (compound of interest), the animal is sacrificed after about 60 to 65 days. The animal's spleen is then removed. The cells are then dissociated according to a standard protocol known to persons skilled in the art.

B—Steps for Cell Fusion and Recovery of Immortalized Cells [Steps (4) and (5)]:

The dissociated cells are exposed to murine myeloma cells. The fusion occurs randomly with a yield estimated at 0.001%. The number of immortalized antibody-producing cells (or hybrid cells, or hybridomas) thus generated at about 3×10⁸ cells.

I-2—Method of Screening:

These steps are illustrated by FIGS. 1 and 2.

A—Distribution Step (10):

The antibody-producing cells or the hybridomas are automatically distributed by a robot forming part of the device for carrying out the method, into 96-well culture plates in an amount of 100 000 cells per well approximately, in a selective medium.

A starting batch of 160 master culture plates are for example thus obtained.

B—Plate Culture Step (12):

The master culture plates are automatically removed daily from the incubator and the culture medium is automatically replaced with new medium.

After 7 days of culture, the culture medium is changed.

This step leads to the iterative screening step (14) (see FIG. 2).

C—Prescreening Module:

a) Transfer Step (140):

The old medium thus collected is deposited into 160 screening plates (screening plates #0) in an amount of 100 μl per well following exactly the same well topography as that presented by the culture plates. These screening plates are designated by references in relation to the master plates using a bar code.

b) Prescreening Step (141):

An anti-IgG antibody coupled to a bead is added in an amount of 10 μl per well to the wells of said screening plates #0. Another antibody coupled to a fluorescent molecule is added in an amount of 10 μl per well. After 10 minutes of incubation at room temperature, the screening plates are read by the FMAT 8200 apparatus (Applied Biosystems) [step. (1411) performed, according to this example, directly in the wells]. According to this method of detection, the fluorochrome is excited with a laser. The apparatus generates an image of antibody-bead complexes provided that at least one IgG population is present in the sample. The specific signal is optimized relative to the background noise, corresponding to the signal emitted by the dissociated reagents.

Each well is associated with the number of photons emitted per second by all the complexes. The wells containing no antibody are characterized by a signal/background noise ratio close to 1 and are eliminated. Likewise, the wells for which the signals obtained have an intensity of less than a threshold value set as a function of the calibration of the test, are also eliminated [step (1412)].

c) Subculturing Step (142):

Depending on these results, the robot selectively collects the cells from the wells of the master culture plates if a significant positive signal has been detected in the corresponding wells of the screening plates #0.

The wells considered are then combined and divided into two identical batches of 4 plates (batches No. 1 and No. 2). These new culture plates (culture plates #1) are designated by references relative to the master culture plates with a bar code.

d) Plate Culture Step (143):

The cells are then cultured in the same manner, for 7 days according to the periodic medium changing protocol described above.

D—Primary Screening Module:

a) Transfer Step (144):

After 7 days of culture, the same cells as those which were used for the immunization [compounds of interest: step (1) above] are automatically distributed into 4 screening plates (screening plates #1) in an amount of 100 000 cells per well, for an initial volume of 50 μl/well.

The culture medium for batch No. 1 of hybridoma culture plates (culture plates #1) is changed. 50 μl of the old medium collected are redeposited into the 4 screening plates (screening plates #1) inoculated with the compounds of interest, following exactly the same well topography. These screening plates #1 are designated by references relative to the culture plates #1 with a bar code.

Concomitantly, batch No. 2 of 4 culture plates #1 is amplified by transferring the contents of each well into 3 wells of a new batch of 12 96-well plates, and cultured for 7 days. Among each triplicate, the wells where the cells exhibit the best growth is selected and the cells are subcultured in a well of a batch of 12 24-well plates. Finally, after 7 days of culture, the cells of each well are transferred into 288 cell culture flasks. After 7 days of culture, the cells are collected, centrifuged and frozen in liquid nitrogen (−173° C.) in order to constitute a first cell library.

b) Primary Screening Step (145):

10 μl of an anti-IgG antibody coupled to a fluorescent molecule are added. After 10 minutes of incubation at room temperature, the screening plates #1 are read by the FMAT 8200 apparatus (step (1452)]. The fluorochrome is excited with a laser and the apparatus generates an image of the labeled cells provided that at least one specific antibody population is present in the sample. The specific signal is distinguished relative to the background noise.

Each well is associated with the number of photons emitted per second by all the cells thus labeled. The wells not containing an antibody specific for an epitope present at the surface of the target cell are characterized by a signal/background noise ratio close to 1 and are eliminated. Likewise, the wells for which the signals obtained have an intensity less than a threshold value set according to the calibration of the test, are also eliminated [step (1453)].

The others, that is 15 wells, are subcultured in three batches of 1 culture plate (batches Nos. 3, 4 and 5).

Batch No. 3 is amplified by transferring the contents of each well into 3 wells of a new batch of 45-well plates, and cultured for 7 days. For each triplicate, the well where the cells exhibit the best growth is selected, and the cells subcultured in a well of a batch of 1 24-well plate. Finally, after 7 days of culture, the cells of each well are transferred into 15 cell culture flasks. After 7 days of culture, the cells are collected, centrifuged and frozen in liquid nitrogen (−173° C.) in order to constitute a second library.

c) Cloning Step (146):

After maintaining the cultures for 7 days, the cells of batch No. 2 are transferred by the robot to cloning tubes.

An anti-IgG antibody coupled to a fluorochrome [e.g. a cyanine (Amersham Biosciences.)] is automatically added to the wells. It specifically binds to the immunoglobulins at the surface of the hybridomas provided that at least one population of cells (or clone) secretes antibodies.

After incubating for 10 minutes, the cells are cloned in a culture plate with the aid of a sorter-analytical flow cytometer, which selectively deposits the cells labeled with the antibody in an amount of one cell per well. 7 positive clones are for example thus obtained.

The steps for subculturing the cloned cells on the culture plates #2, [step (147)] and plate culture [step (148)] are identical to those described above.

E—Secondary Screening Module:

a) Transfer Step (149):

After 7 days of culture, the same cells as those which were used for the immunization [compounds of interest: step (1)] are automatically distributed in 1 screening plate (screening plate #2) in an amount of 100 000 cells per well, for an initial volume of 50 μl/well.

Another batch of two screening plates #2 is inoculated with cells obtained from the same tissue as the target cells, but having a healthy phenotype. These cells are termed “normal” or “controls”.

The culture medium of batch No. 1 of hybridoma culture plates (culture plates #2) is changed. The old medium is stored. 50 μl of this medium are deposited in the screening plate #2 inoculated with the target cells. Another 50 μl of old medium are deposited in the batch inoculated with the control cells following exactly the same well topography. These screening plates #2 are designated by references relative to the culture plates #2 with bar codes.

b) Secondary Screening Step (150):

10 μl of an anti-IgG antibody coupled to a fluorescent molecule are added to said screening plates #2.

After incubating for 10 minutes at room temperature, the screening plates #2 are read by the FMAT 8200 apparatus [step (1502)]. The apparatus generates an image of the labeled cells, provided at least one antibody population specific for either of the cell types (tumor or normal) is present in the sample. The specific signal is distinguished relative to the background noise.

By comparison between the wells containing the same, supernatant sample, the antibodies specifically directed against the target cells are identified. This corresponds for example to 3 clones [step (1503)].

Immediately after collecting the culture supernatants, the cell clones are amplified by transferring each well into 3 wells of a new batch of 21-well plate, and cultured for 7 days.

For each triplicate, the well where the cells exhibit the best growth is selected, and the cells are subcultured in a well of a batch of 1 24-well plate. Finally, after 7 days of culture, the cells of each well are transferred to 7 cell culture flasks. After 3 to 7 days of culture, the cells are collected, centrifuged and frozen in liquid nitrogen (−173° C.) in order to prepare a third library.

The steps of selective subculturing of the cells on the culture plates #3 [step (151)] and plate culture [step (152)] are identical to those described above.

F—Tertiary Screening Module:

a) Transfer Step (153):

The culture supernatants for the 3 clones identified during the secondary screening are collected and deposited in 3 wells of a screening plate #3.

b) Tertiary Screening Step (154)

The affinity of the antibodies for the antigen is analyzed using a Biacore 3000 type apparatus [step (1542)].

The antibodies are classified according to the affinity and/or kinetic constants obtained [step (1543)]. At this stage, two antibodies for example remain.

The total antigens of the target cells are isolated by proteomic techniques and immobilized by Western blotting. The two antibodies selected during the tertiary screening are deposited on the proteins thus bound. After incubation, an anti-IgG antibody labeled with a fluorochrome (for example fluoroscein) is added. The antigen specific for each antibody is identified by detection of the fluorescence [step (15422)].

II—Method for Improving the Production of Antibody-Producing Cells:

The example which follows illustrates the case where the compound of interest considered is a tumor cell [steps (30) to (38)].

II-1—Materials and Methods [Steps (30) and (32)]:

The experiments were carried out in mice, with murine dendritic cells, and murine myeloma cells (SP2/O).

The hybrid dendritic cells (DH cells) obtained by fusion [step (30)] were analyzed. They possess the character of mouse dendritic cells (recognition by antibodies specific for these cells in cytofluorometry). In addition, they have at their surface the epitopes, including the cryptic epitopes, of the tumor cell. The later characteristic is verified after fusion of dendritic cells and myeloma cells SP2/O and observation by electron microscopy. The presence of intracisternal A particles (IAP) was exclusive to the SP2/O cells, which was confirmed by hybridization.

II-2—Immunization Step (34) and Next Steps:

The immunization protocol was as follows. Four groups of four Balb/c mice were treated as follows:
group A: 4, mice were immunized with SP2/O cells;
group B: 4 mice were immunized with irradiated (UV) SP2/O cells;
group C: 4 mice were immunized with nonirradiated DH cells; and
group D: 4 mice were immunized with irradiated (UV) DH cells.

The mortality was observed over a standard period of one month after the first inoculation.

The analysis of the humoral immune response (or immunization level) [step (36)] was carried out with the aid of the ELISA technique. The tests were carried out using serum samples diluted one thousand fold on 96-well plates coated with SP2/O cells, in order to qualitatively evaluate the presence of antibodies directed against the antigens of these cells in the serum of the treated animals.

The scale adopted for the, measurement was the following:
0 no response
+ weak response
++ average response
+++ high response
++++ very high response.

The results obtained are the following:
group A: as expected, the mortality due to metastasis (ascites) was 100%, with an average survival of 10 to 15 days.
group. B: there was no mortality and the immune response against the SP2/O cells was approximately ±, and could range up to + against fixed SP2/O cells.
group C: the results were similar to those observed with group A, with a high mortality.
group D: there was no mortality and the immune response was between +++ and ++++.

Groups B and D were subjected to, the inoculation of nonirradiated SP2/O cells (therefore capable of inducing a tumor response with ascites). In group B, the mortality was 100%, whereas in group D, the mice remain in good health after 4 months.

1. An automated method for the large-scale in vitro screening of cells secreting at least one specific monoclonal antibody with affinity for a compound of interest, said method comprising at least the following steps:
(10) distribution of antibody-producing cells in at least one well of at least one culture plate;
(12) culturing said cells under conditions allowing their growth, with concomitant detection of cellular growth and of the quality of the cultures;
(14) iterative screening of said cells for the secretion of antibodies, with cloning of the cells secreting at least one antibody interacting with said compound of interest; and
(16) selection of at least one cell secreting one specific monoclonal antibody with affinity for said compound of interest.

2. The method as claimed in claim 1, wherein said compound of interest is an antigen comprising at least one epitope.

3. The method as claimed in claim 2, wherein said antigen is chosen from the group consisting of proteins, nucleic acids, viral particles, synthetic peptides, chemical compounds, organs, organelles, whole cells, and subcellular fragmentations.

4. The method as claimed in claim 3, wherein said antigen is a tumor cell.

5. The method as claimed in claim 1, wherein said distribution according to step (10) is carried out in an amount of at least 3×10⁵ cells per well.

6. The method as claimed in claim 1, wherein each step is performed in a sterile atmosphere.

7. The method as claimed in claim 1, wherein said step (10) is at least preceded by the following preliminary steps:
(1) immunization of at least one animal, with said compound of interest;
(2) optionally, measurement of the immune response of said animal; and
(3) recovery of the antibody-producing cells.

8. The method as claimed in claim 1, wherein said step (10) is at least preceded by the following preliminary steps:
(0) bringing at least one dendritic cell and said compound of interest into contact, such that said dendritic cell presents at least one epitope of said compound of interest;
(1) immunization of at least one animal, with said dendritic cell presenting said epitope;
(2) optionally, measurement of the immune response of said animal; and
(3) recovery of the antibody-producing cells.

9. The method as claimed in claim 8, wherein, when said compound of interest is a tumor cell, said step (0) comprises at least:
(01) the fusion of said dendritic cell and said tumor cell; and
(02) the recovery of at least one hybrid dendritic cell.

10. The method as claimed in claim 7, wherein said preliminary steps additionally comprise:
(4) the fusion of said antibody-producing cells with immortalized cells; and
(5) the recovery of the immortalized antibody-producing cells.

11. The method as claimed in claim 7, wherein said antibody-producing cells are chosen from the group consisting of mouse, rat, rabbit, and human cells.

12. The method as claimed in claim 11, wherein said antibody-producing cells are mouse cells.

13. The method as claimed in claims 7, wherein said preliminary steps are not automated.

14. The method as claimed in claim 1, wherein said iterative screening step (14) comprises at least the following screening module, which may be repeated:
transfer of the culture medium collected from at least one well of at least one culture plate, into at least one well of at least one screening plate;
screening of the cells for at least one given selection criterion;
selective subculturing of the cells satisfying said criterion into at least one well of at least one new culture plate; and
culture of said cells under conditions allowing their growth, with concomitant detection of cell growth and of the quality of the cultures.

15. The method as claimed in claim 14, wherein said step (14) comprises a prescreening module in which said selection criterion is the secretion of antibodies:
(140) transfer of the culture medium to at least one well of at least one screening plate;
(141) prescreening of the cells for the secretion of antibodies;
(142) selective subculturing of the cells secreting at least one antibody on at least one culture plate; and
(143) culture of said cells.

16. The method as claimed in claim 14, wherein said step (14) comprises a primary screening module in which said selection criterion is the secretion of antibodies interacting with said compound of interest:
(144) transfer of the culture medium to at least one well of at least one screening plate;
(145) primary screening of said cells for the secretion of at least one antibody interacting with said compound of interest;
(146) cloning of the cells secreting at least one antibody interacting with said compound of interest;
(147) subculturing of the cloned cells on at least one culture plate; and
(148) culture of said cells.

17. (canceled)

18. The method as claimed in claim 16, wherein said step (14) additionally comprises a secondary screening module, in which said selection criterion is the secretion of monoclonal antibodies specific for said compound of interest:
(149) transfer of the culture medium to at least one well of at least one screening plate;
(150) secondary screening of said cells for the secretion of a monoclonal antibody specific for said compound of interest;
(151) selective subculturing of the cells secreting a monoclonal antibody specific for said compound of interest on at least one culture plate; and
(152) culture of said cells.

19. The method as claimed in claim 18, wherein said step (14) additionally comprises a tertiary screening module, in which said selection criterion is the secretion of specific monoclonal antibodies with affinity for said compound of interest:
(153) transfer of the culture medium to at least one well of at least one screening plate;
(154) tertiary screening of said cells for the secretion of a specific monoclonal antibody with affinity for said compound of interest; and
(155) optionally, selective subculturing of the cells secreting a specific monoclonal antibody with affinity for said compound of interest on at least one culture plate; and
(156) optionally, culture of said cells.

20. The method as claimed in claim 1, wherein said step (16) comprises:
(16) the selection of at least one cell secreting a monoclonal antibody with specificity and/or affinity for said compound of interest greater than those of the monoclonal antibodies secreted by the other cells.

21. The method as claimed in claim 1, wherein said culture is carried out over a period of between at least 7 days and at most 21 days.

22. The method as claimed in claim 14, wherein a cell library is prepared for at least one screening module.

23. The method as claimed in claim 15, wherein said step (141) comprises at least:
(1411) the detection of the secretion of antibodies; and
(1412) the selection of cells secreting at least one antibody.

24. The method as claimed in claim 23, wherein said step (1411) comprises at least:
(14111) the collection of at least one culture supernatant sample; and
(14112) the detection of the secretion of antibodies in said sample.

25. The method as claimed in claim 23, wherein said step (1411) comprises at least the detection of the secretion of antibodies directly in the wells.

26. The method as claimed in claim 16, wherein said step (145) comprises at least:
(1451) the collection of at least one culture supernatant sample;
(1452) the detection, in said sample, of the interaction of the antibodies with said compound of interest; and
(1453) the selection of cells secreting at least one antibody interacting with said compound of interest.

27. The method as claimed in claim 18, wherein said step (150) comprises at least:
(1501) the collection of at least one culture supernatant sample;
(1502) the detection, in said sample, of a specific interaction between a monoclonal antibody and said compound of interest; and
(1503) the selection of cells secreting a monoclonal antibody specific for said compound of interest.

28. The method as claimed in claim 19, wherein said step (154) comprises at least:
(1541) the collection of at least one culture supernatant sample; and
(1542) the measurement of the affinity of a monoclonal antibody for said compound of interest.

29. The method as claimed in claim 28, wherein step (1542) comprises at least:
(15421) the measurement of the affinity of a monoclonal antibody for said compound of interest; and
(15422) the identification and/or the location of at least one epitope of said compound of interest.

30. The method as claimed in claim 29, wherein said steps (15421) and (15422) are concomitant.

31. The method as claimed in claim 28, wherein step (154) additionally comprises:
(1543) the classification of the monoclonal antibodies on the basis of their specificity and/or their affinity for said compound of interest.

32. The method as claimed in claim 8, wherein said preliminary steps additionally comprise:
(4) the fusion of said antibody-producing cells with immortalized cells; and
(5) the recovery of the immortalized antibody-producing cells.

33. The method as claimed in claim 8, wherein said antibody-producing cells are chosen from the group consisting of mouse, rat, rabbit, and human cells.

34. The method as claimed in claim 33, wherein said antibody-producing cells are mouse cells.

35. The method as claimed in claim 8, wherein said preliminary steps are not automated.

36. The method as claimed in claim 10, wherein said preliminary steps are not automated.

37. The method as claimed in claim 32, wherein said preliminary steps are not automated.

38. The method as claimed in claim 14, wherein said step
(14) comprises:
(a) a prescreening module in which said selection criterion is the secretion of antibodies:
(140) transfer of the culture medium to at least one well of at least one screening plate;
(141) prescreening of the cells for the secretion of antibodies;
(142) selective subculturing of the cells secreting at least one antibody on at least one culture plate; and
(143) culture of said cells; and
(b) a primary screening module in which said selection criterion is the secretion of antibodies interacting with said compound of interest:
(144) transfer of the culture medium to at least one well of at least one screening plate;
(145) primary screening of said cells for the secretion of at least one antibody interacting with said compound of interest;
(146) cloning of the cells secreting at least one antibody interacting with said compound of interest;
(147) subculturing of the cloned cells on at least one culture plate; and
(148) culture of said cells.

39. The method as claimed in claim 38, wherein said step (14) additionally comprises a secondary screening module, in which said selection criterion is the secretion of monoclonal antibodies specific for said compound of interest:
(149) transfer of the culture medium to at least one well of at least one screening plate;
(150) secondary screening of said cells for the secretion of a monoclonal antibody specific for said compound of interest;
(151) selective subculturing of the cells secreting a monoclonal antibody specific for said compound of interest on at least one culture plate; and
(152) culture of said cells.

40. The method as claimed in claim 39, wherein said step (14) additionally comprises a tertiary screening module, in which said selection criterion is the secretion of specific monoclonal antibodies with affinity for said compound of interest:
(153) transfer of the culture medium to at least one well of at least one screening plate;
(154) tertiary screening of said cells for the secretion of a specific monoclonal antibody with affinity for said compound of interest; and
(155) optionally, selective subculturing of the cells secreting a specific monoclonal antibody with affinity for said compound of interest on at least one culture plate; and
(156) optionally, culture of said cells.

41. The method as claimed in claim 14, wherein said culture is carried out over a period of between at least 7 days and at most 21 days.

42. The method as claimed in claim 21, wherein said period is between 7 and 15 days.

43. The method as claimed in claim 41, wherein said period is between 7 and 15 days.

44. The method as claimed in claim 39, wherein said step (150) comprises at least:
(1501) the collection of at least one culture supernatant sample;
(1502) the detection, in said sample, of a specific interaction between a monoclonal antibody and said compound of interest; and
(1503) the selection of cells secreting a monoclonal antibody specific for said compound of interest.

45. The method as claimed in claim 40, wherein said step (154) comprises at least:
(1541) the collection of at least one culture supernatant sample; and
(1542) the measurement of the affinity of a monoclonal antibody for said compound of interest.

46. The method as claimed in claim 45, wherein step (1542) comprises at least:
(15421) the measurement of the affinity of a monoclonal antibody for said compound of interest; and
(15422) the identification and/or the location of at least one epitope of said compound of interest.

47. The method as claimed in claim 46, wherein said steps (15421) and (15422) are concomitant.

48. The method as claimed in claim 45, wherein step (154) additionally comprises:
(1543) the classification of the monoclonal antibodies on the basis of their specificity and/or their affinity for said compound of interest.
